(19) United States
(12) Patent Application Publication
(10) Pub. No.: US 2010/0005199 A1
(43) Pub. Date: Jan. 7, 2010

(54) DIRECT MEMORY ACCESS (DMA) DATA TRANSFERS WITH REDUCED OVERHEAD

(75) Inventor: Salil Shirish Gadgil, Pune (IN)

Correspondence Address: TEXAS INSTRUMENTS INCORPORATED, P O BOX 655474, M/S 3999, DALLAS, TX, 75265, US

(73) Assignee: TEXAS INSTRUMENTS INCORPORATED, Dallas, TX (US)

(21) Appl. No.: 12/420,833

(22) Filed: Apr. 9, 2009

(30) Foreign Application Priority Data
Jul. 7, 2008 (IN) 1644/CHE/2008

(51) Int. Cl. G06F 13/28

(52) U.S. Cl. 710/22

(57) ABSTRACT

A digital processing system, in which a single interrupt to a processor is used in transferring multiple messages in the form of corresponding packets. In an embodiment, a processor continues to write messages to a transmit first-in-first-out (FIFO) along with a length of the message in a header of a packet. A direct memory access (DMA) controller compares the length indicated in the header with the unread data in the transmit FIFO to determine whether a complete message is stored in the transmit FIFO. DMA controller starts transmission of only complete messages thereafter. A single interrupt is generated when no complete message is determined to be present in the transmit FIFO. Similar features may be used to reduce interrupts to the processors, when transmitting data to the processor.

### RELATED APPLICATION(S)

The present application claims the benefit of co-pending India provisional application serial number: 1644/CHE/2008, entitled: “Self Initiated DMA for reducing DMA related processor and storage overheads”, filed on Jul. 7, 2008, naming Texas Instruments Inc. (the intended assignee) as the Applicant, and naming the same inventors as in the present application as inventors, attorney docket number: TXN-954, and is incorporated in its entirety herewith.

### BACKGROUND OF THE INVENTION

1. Technical Field

Embodiments of the present disclosure relate generally to data transfers in a digital processing system, and more specifically to direct memory access (DMA) data transfers with reduced overhead.

2. Related Art

There is often a need to transfer data from one location to another location in digital processing systems. For example, data is often transferred to/from peripheral devices (e.g., printers, serial/parallel port controllers, modems, etc.). As another example, data is transferred from one portion of a memory to another portion of the same memory for purposes such as rotation of an image frame, etc., as is also well known in the relevant arts.

In one prior approach, a central processing unit (CPU) is used to effect such transfers from one location to another. At least in case of peripheral devices, which often have limited buffer/processing capabilities, the CPU may be interrupted for transferring fairly small portions of the overall data and the CPU may be interrupted several times. As the interrupts generally cause substantial overhead on the CPU, other applications (e.g., user applications such as playing songs, word processing, databases, etc.) may be deprived of such processing resource due to the interrupts.

Direct Memory Access (DMA) is a well known technique to transfer data while reducing overhead on CPUs. In a typical DMA based transfer, a CPU stores a desired data set (“packet”) to be transferred in a memory (operating at high speed) and then notifies a DMA controller to complete the transfer to a desired target component (peripheral device, memory, etc.). Once that transfer of the requested data set is complete, the CPU may be notified of the completion by an appropriate interrupt. In such an approach, the number of interrupts received by a processor equals the number of desired data sets the processor requests to be transferred.

The desired data set processed based on each interrupt is typically several times the magnitude of what a peripheral may accept in a single transfer, and thus the number of interrupts to a CPU is greatly reduced, thereby reducing the overhead on the CPU. As a consequence, user applications may have enhanced processing resources, which leads to corresponding benefits.

There is a general need to further reduce overheads while performing DMA transfers.

### SUMMARY

This Summary is provided to comply with 37 C.F.R. §1.73, requiring a summary of the invention briefly indicating the nature and substance of the invention. It is submitted with the understanding that it will not be used to interpret or limit the scope or meaning of the claims.

An aspect of the present invention reduces the number of interrupts to a processor by generating a single (only one) interrupt after transferring multiple messages stored in the form of corresponding packets in FIFO. A packet is a self-contained unit, which indicates the message (data set) to be transmitted as well as the destination to which the packet is to be transferred.

In an embodiment, with respect to transmission, a processor continues to write messages to a transmit first-in-first-out (FIFO) along with a length of the message in a header of a packet. A direct memory access (DMA) controller compares the length indicated in the header with the unread data in the transmit FIFO to determine whether a complete message is stored in the transmit FIFO. DMA controller starts transmission of only complete messages thereafter. A single interrupt is generated when no complete message is determined to be present in the transmit FIFO.

Due to such use of a single (only one) interrupt, the overhead on the processor may be reduced. Similar features may be used to reduce interrupts to the processors, when transmitting data to the processor.

Several aspects of the invention are described below with reference to examples for illustration. It should be understood that numerous specific details, relationships, and methods are set forth to provide a full understanding of the invention. One skilled in the relevant art, however, will readily recognize that the invention can be practiced without one or more of the specific details, or with other methods, etc. In other instances, well-known structures or operations are not shown in detail to avoid obscuring the features of the invention.

### BRIEF DESCRIPTION OF THE VIEWS OF DRAWINGS

Example embodiments of the present invention will be described with reference to the accompanying drawings briefly described below.

FIG. 1 is a block diagram of an example environment in which several features of the present invention can be implemented.

FIG. 2A is a flowchart illustrating the manner in which a CPU writes data into a FIFO, with the data intended for DMA-transfer to peripheral devices, in an embodiment of the present invention.

FIG. 2B is a diagram illustrating example contents and storage format in FIFOs, in an embodiment of the present invention.

FIG. 2C is a timeline illustrating example sequence of operations performed in transferring data to a peripheral, in an embodiment of the present invention.

FIG. 3 is a flowchart illustrating the manner in which a DMA controller transfers data from a FIFO to a peripheral device in an embodiment of the present invention.

FIG. 4 is a flowchart illustrating the manner in which a DMA controller stores data received from a peripheral device in a FIFO in an embodiment of the present invention.

FIG. 5 is a flowchart illustrating the manner in which a CPU reads data from a FIFO in an embodiment of the present invention.

FIG. 6 is a block diagram illustrating relevant internal details of a transmit FIFO, a receive FIFO, and a DMA controller implemented using hardware, in an embodiment of the present invention.

The drawing in which an element first appears is indicated by the leftmost digit(s) in the corresponding reference number

### DETAILED DESCRIPTION

Various embodiments are described below with several examples for illustration.

1. Example Environment

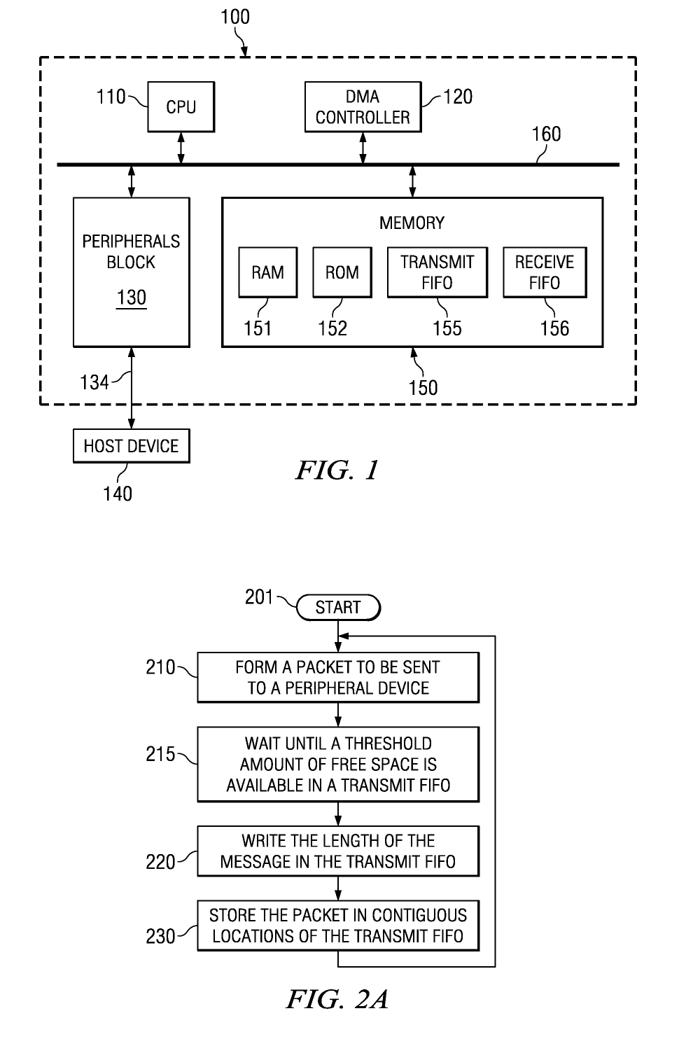

FIG. 1 is a block diagram of an example environment in which several aspects of the present invention can be implemented. The diagram is shown containing integrated circuit (IC) 100 and host device 140. The details of FIG. 1 are provided merely by way of illustration, and other environments in which features of the present invention find application may contain more or fewer components.

Host device 140 represents a device external to IC 100, and may send and/or receive data to/from IC 100 via path 134. Host device 140 represents a system or a device which operates in conjunction with IC 100 to provide desired applications/features.

IC 100 may be implemented as a system-on-chip (SoC) and represents an example digital processing system. IC 100 is shown containing CPU 110, DMA controller 120, peripherals block 130 and memory 150. Again, the internal details of IC 100 shown in FIG. 1 are provided merely by way of illustration. Other implementations of IC 100 may contain more or fewer components, without departing from the scope and spirit of several aspects of the present invention. Blocks/components within IC 100 may communicate with each other via bus 160.

Memory 150 is shown containing random access memory (RAM) 151, read-only memory (ROM) 152, transmit FIFO (first-in first-out) 155, and receive FIFO 156. In general, a FIFO contains memory locations plus control logic to control accesses to the memory locations (in a first-in-first-out manner), and thus, each of transmit FIFO 155 and receive FIFO 156 contains memory locations for storage as well as corresponding control logic. Thus each FIFO is also referred to as a FIFO memory. Although not shown in FIG. 1, memory 150 may also contain other types of memory such as, for example, flash memory. RAM 151 and ROM 152 serve as general purpose storage elements for storage of instructions (to be executed by CPU 110), as well as for storing data.

Transmit FIFO 155 stores data elements received from CPU 110, and which are to be transferred to peripherals in peripherals block 130 using DMA. Receive FIFO 156 stores data (intended for CPU 110) retrieved by DMA controller 120 from peripherals in peripherals block 130. In an embodiment, each of transmit FIFO 155 and receive FIFO 156 is implemented as a circular FIFO, and is described in greater detail in sections below. Although not shown in FIG. 1, in some environments, a memory controller may be present between bus 160 and memory 150, and controls/coordinates all accesses to memory 150.

CPU 110 executes instructions stored in memory 150 to provide desired features/applications, and may contain multiple processing units (processors), with each processing unit potentially being designed for a specific task. Alternatively, CPU 110 may contain only a single general-purpose processing unit. CPU 110 stores data to be transferred to peripherals in peripherals block 130 using DMA in transmit FIFO 155, and retrieves (reads) data sent by the peripherals from receive FIFO 156.

Peripherals block 130 represents one or more peripheral devices. The peripheral devices may operate to provide specific functions themselves (e.g., a modem), or provide an interface between CPU 110 and an external device such as host device 140 (e.g., serial/parallel input/output interface controllers). In an embodiment of the present invention, peripherals block 130 includes SDIO (Secure Digital Input Output) bus interfaces, and SPI interfaces (Serial Peripheral Interface Bus, a synchronous serial data link).

DMA controller 120 performs DMA data transfers according to several aspects of the present invention. The data transfers may be between two sets/chunks of memory locations in memory 150 (excluding locations in transmit FIFO 155 and receive FIFO 156), between transmit FIFO 155 and target locations (e.g., memory/register/FIFO) in peripherals contained in peripherals block 130, or between receive FIFO 156 and corresponding target locations in peripherals block 130.

DMA controller 120 in conjunction with transmit FIFO 155 and receive FIFO 156 operate to reduce CPU-overhead (interventions required by CPU 110) during DMA data transfers according to an aspect of the present invention. The manner in which such reduction is achieved in an example scenario, is described next with respect to flowcharts.

2. Reducing CPU Overhead

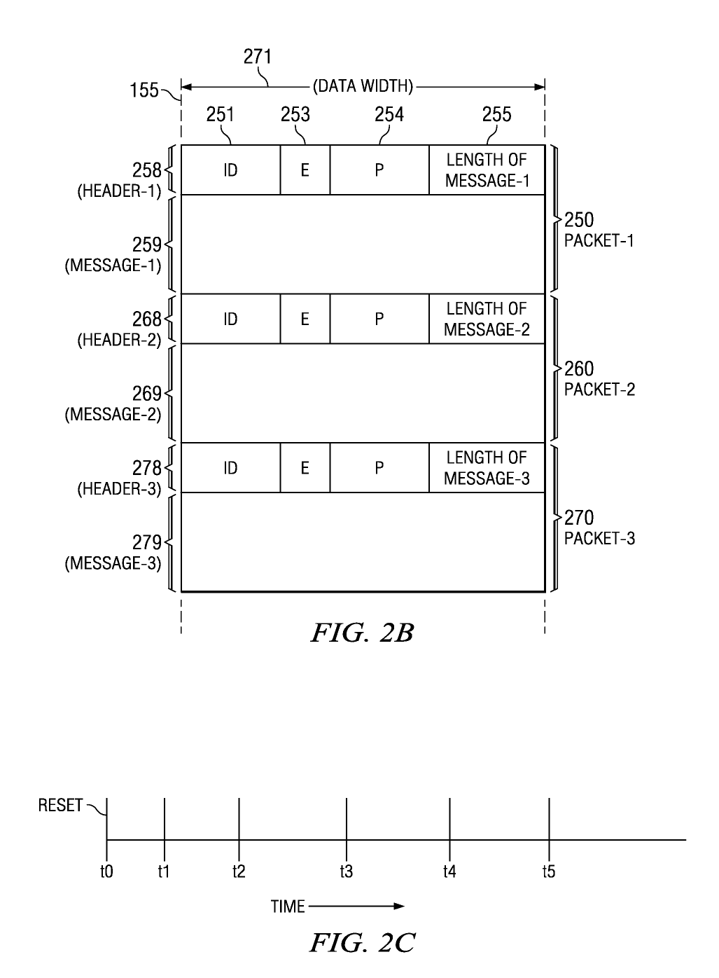

FIG. 2A is a flowchart illustrating the manner in which a CPU writes data to be DMA-transferred to peripherals, in an embodiment of the present invention. The flowchart is described with respect to FIGS. 1 and 2B (which is a diagram illustrating the content of a transmit FIFO in an embodiment) merely for illustration. However, various features can be implemented in other environments and other components as well. Furthermore, the steps in the flowcharts are described in a specific sequence merely for illustration.

Alternative embodiments in other environments, and using a different sequence of steps, can also be implemented without departing from the scope and spirit of several aspects of the present invention, as will be apparent to one skilled in the relevant arts by reading the disclosure provided herein. The flowchart starts in step 201, in which control passes immediately to step 210.

In step 210, CPU 110 forms a data packet (packet) to be sent to a peripheral device. Each packet contains a message (data units) sought to be transferred and also at least some of the header information as described below with respect to FIG. 2B. Control then passes to step 215.

In step 215, CPU 110 waits until a threshold amount of free space is available in transmit FIFO 155. The threshold amount can equal as small as a single byte, but alternative embodiments may wait for availability of more bytes (potentially the size of the entire message/packet). In an embodiment, each FIFO is implemented to have a write pointer (TWP) and a read pointer (TRP), which point to the next location in the FIFO at which data is to be written and read from respectively.

CPU 110 may make a determination of availability of space (equaling the threshold amount) computing a difference of the contents of write (TWP) and read (TRP) pointers of transmit FIFO 155, then checking if the difference of the total size of transmit FIFO 155 and (TWP-TRP) is at least equal to the threshold amount. CPU 110 may perform other operations/tasks (related potentially to other user applications, which are unrelated to the application generating the data for transfer) till sufficient space becomes available.

Alternatively and/or in other embodiments, the size of transmit FIFO 155 may be determined a priori during system architecture phase of IC 100 such that a ‘FIFO full’ condition never occurs at least in practical/typical situations. In an alternative embodiment, the size of transmit FIFO 155 may be implemented to be adjustable dynamically when the memory space forming the basis for the FIFO is shared with other applications.

In step 220, CPU 110 writes the length of the message in transmit FIFO 155. In an embodiment, the length of the message specifies the total number of data units (e.g., bytes) contained in the packet, excluding header information such as identifier of packet, the length itself, etc. Control then passes to step 230.

In step 230, CPU 110 stores the (data elements of the) packet in contiguous (or successive) locations of transmit FIFO 155. Control then passes to step 210, in which CPU 110 forms another packet, and the steps described above are repeated. Packets are also stored in contiguous locations, as may be noted by observing FIG. 2B, described below.

FIG. 2B is a diagram illustrating example contents of transmit FIFO 155 as might be created by CPU 110, according to the description provided above with respect to FIG. 2A.

FIG. 2B shows three packets stored by CPU 110, with the start location of a later packet following the end location of a previous packet in the sequence.

Packet-1 (250) contains a header portion (Header-1 (258)), and a message portion (Message-1 (259)). The portion Message-1 (259) stores data contained in Message-1. Packet-2 (260) contains Header-2 (268) and Message-2 (269), and Packet-3 (270) contains Header-3 (278) and Message-3 (279). Data width (271) represents the width (number of bits) in each addressable location of transmit FIFO 155.

As noted with respect to the flowchart of FIG. 2A, CPU writes the length (e.g., size in terms of number of bytes) of a message in the corresponding header field of the packet. For example, assuming the length of Message-1 (e.g., number of bytes) equals 100, CPU 110 writes 100 in ‘length field’ 255 (noted as “Length of Message-1”). In an embodiment, in addition to the length, CPU 110 may also store the identifier of Message-1 in field 251 (‘ID’), flags reflecting error conditions in field 253 (‘E’), and the peripheral device to which Message-1 is to be transferred in field 254 (‘P’). CPU 110 then stores the data representing Message-1 in the following locations of transmit FIFO 155, contiguously. Packet-2 and packet-3 are stored in a similar manner.

DMA controller 120 transfers the packets stored in transmit FIFO 155, as described next with an example.

3. DMA Transfer

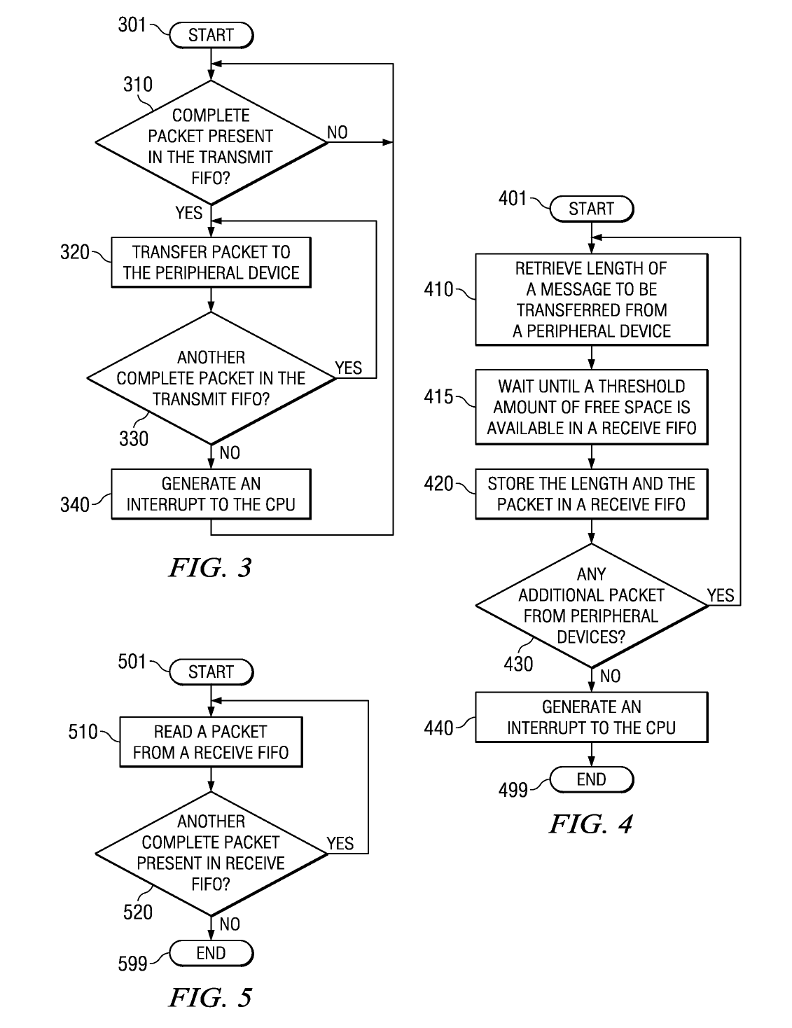

The flowchart of FIG. 3 is described with respect to FIG. 1, and the components of IC 100 merely for illustration. However, various features can be implemented in other environments and other components as well. Furthermore, the steps in the flowcharts are described in a specific sequence merely for illustration. The flowchart starts in step 301, in which control passes immediately to step 310.

In step 310, DMA controller 120 checks if a complete packet is present in transmit FIFO 155. If DMA controller 120 determines that a complete packet, i.e., all data (message) contained in the packet is present, then control passes to step 320. However, if only a portion of a packet (incomplete packet) is present, DMA controller 120 continues in step 310, i.e., waits till a complete packet is stored by CPU 110.

In an embodiment, DMA controller 120 reads the ‘length field’ in a header of a packet, and checks if the difference of the ‘current’ values of the write pointer and read pointer of FIFO 155 is greater than the length or not, i.e., the following inequality:

(TWP−TRP)>length,

wherein,

TWP is the ‘current’ value of the write pointer of FIFO 155,

TRP is the ‘current’ value of the read pointer of FIFO 155, and length is the length of the corresponding message.

A true value of the above inequality implies that the complete packet is present. Otherwise, only a partial packet is deemed to be present.

In step 320, DMA controller 120 transfers the packet to a peripheral device specified as the recipient (in field P 254). Control then passes to step 330, in which DMA controller 120 checks if another (complete) packet is present in transmit FIFO 155. If DMA controller 110 determines that such a complete packet is present, control passes to step 320, otherwise control then passes to step 340.

In step 340, DMA controller 120 generates an interrupt to CPU 110. The corresponding interrupt service routine (ISR) may be designed to indicate to CPU 110 the number, message identifier(s), etc, of the message(s) that have been transferred by DMA controller 110. Control then passes to step 310.

Thus, in accordance with FIG. 3, an interrupt is generated to CPU 110 if there are no further completely formed packets already in the transmit FIFO upon completion of transfer of a prior packet. However, in alternative embodiments, when at least a substantial part of the packet is present in the transmit FIFO, control may be transferred from step 330 to step 310.

It should be further appreciated that the approach of FIG. 3 transfers multiple completely formed packets (complete packets, as against only a portion(s) of a packet/message), and only then is an interrupt (only one/single interrupt) generated for the CPU. As a result, the number of interrupts to CPU is reduced, thereby reducing the overhead on CPU.

In alternative embodiments, a limit may be imposed on the number of messages transferred before an interrupt is generated. Such modifications, without departing from the spirit of several aspects of the present invention, will be apparent to one skilled in the relevant arts by reading the disclosure provided herein.

Furthermore, the transfer to a peripheral starts only after a (complete) packet is deemed to be stored in the transmit FIFO. Such a feature may be required, for example, when operating in conjunction with some peripheral devices (e.g., synchronous devices such as SPI), which require that the entire message be transferred in a continuous time duration (without breaks/interruptions).

The operations noted above are illustrated with an example sequence of events below.

4. Transfer illustrated

FIG. 2C is a timing diagram used to illustrate the data transfer in an example scenario. It is assumed in FIG. 2C that data width (271) of transmit FIFO 155 is one byte, and that Message-1 (FIG. 2B) is the first message to be stored in transmit FIFO 155 following reset of IC 100. Time t0 represents a time instance at which all components of IC 100 are reset. Write pointer (TWP) and read pointer (TRP) have values of 0 at time t0.

At time instance t1, CPU 110 writes a value of 100 in length field 255 of Message-1 of FIG. 2B. CPU 110 may also enter corresponding values for fields 251, 253 and 254. TWP is incremented to a value 1. CPU 110 then writes the first data byte of Message-1 in the location specified by the contents (currently 001) of TWP. CPU 110 continues writing data bytes, with TWP being incremented after each write. It is assumed in the example that CPU 110 completes storing all data of Message-1 at time instance t3. At the completion of writing of the last byte of Message-1, TWP would have a value of 100. Assume that at time t2, DMA controller 120 reads Header-1 (FIG. 2B) to obtain the length of Message-1 from length field 255. TRP is incremented to 001. Immediately subsequently (a delta time delay after t2, and earlier than t3), DMA controller 120 computes the inequality [(TWP−TRP)>100]. At time instance t2, CPU 110 would have stored less (say 50 bytes) than 100 bytes of Message-1. DMA controller 120, thus, evaluates the inequality [(TWP−TRP)>100] as false. Hence, as described above with respect to step 310, DMA controller continues to wait till all 100 bytes are stored, and then transfers (step 320) Packet-1 (Header-1 plus Message-1) to the peripheral device specified by field 251. It is assumed that DMA controller 120 completes the transfer by time t5.

Corresponding to the operation of step 330, DMA controller 120 then checks if any additional packets are contained in FIFO 155. In the current example, after having transferred the last data byte of Message-1, DMA 120 would determine if (TWP−TRP)>0. A value of (TWP−TRP) greater than zero signifies that CPU 110 has stored at least one data byte following the last byte of Message-1.

If (TWP−TRP)>0 evaluates true, DMA controller 120 reads the next memory location (corresponding to Header-2 in the example) to determine the length of Message-2. Assuming CPU 110 had completed storing all data of packet-2 by time instance t4, and that the length of Packet-2 equals 40 bytes, DMA controller 120 would evaluate the expression [(TWP−TRP)>40] to be true, and would transmit Packet-2.

Assuming packet-2 to be the last packet stored by CPU 110 (ignoring Packet-3 of FIG. 2B in this example), DMA controller would generate an interrupt to CPU 110 once all bytes of Packet-2 have been transferred. Operations as described above would be performed for packets stored at later time instances, with DMA controller 120 continuously evaluating (TWP−TRP)>0 to determine if additional packets (stored at later time intervals than t5) need to be transferred.

Thus, DMA controller 120 autonomously (without requiring intervention of any other component such as CPU 110) determines if all data corresponding to a packet (or packets) has (have) been stored for DMA-transfer, and performs data transfer of all complete packet(s). At the end of transfer of the last complete packet, DMA controller 120 interrupts CPU 110.

It may be appreciated from the foregoing description that since CPU 110 is interrupted (once) only after all completely stored packets are transferred, CPU 110-overhead is reduced. Further, the technique ensures uninterrupted transmission of a packet, since all data of a packet are first ensured available before start of transfer, thereby enabling data transfer to peripherals such as, for example SPI and SDIO, that may not support broken data transfer of a packet. Various other benefits of the approach include autonomous initiation of transfers to peripherals by DMA controller 120, and accommodation of smaller packet sizes without undue CPU 110 overhead (by way of interrupts after each packet is transferred).

The description is continued with respect to operations performed by CPU 110 and DMA controller 120 for transferring data from peripherals block 130 to receive FIFO 156 in an embodiment.

5. Data Transfers to CPU

FIG. 4 is a flowchart illustrating the manner in which a DMA controller transfers data from a peripheral device to a receive FIFO in an embodiment. The flowchart starts in step 401, in which control passes immediately to step 410.

In step 410, DMA controller 120 retrieves from a corresponding location in memory (RAM/FIFO/ROM etc.) in a peripheral device, a data value specifying the length of a message to be transferred from the peripheral device. Control then passes to step 415.

In step 415, DMA controller 120 waits until a threshold amount of free space is available in receive FIFO 156. The threshold amount can equal as small as a single byte, but alternative embodiments may wait for availability of more bytes (potentially the size of the entire message/packet). DMA controller 120 may make a determination of whether sufficient space (equaling the threshold amount) is available or not by computing a difference of the contents of write (RWP) and read (RRP) pointers of receive FIFO 156, then checking if the difference of the total size of receive FIFO 156 and (RWP-RRP) is at least equal to the threshold amount. Alternatively and/or in other embodiments, the size of receive FIFO 156 may be determined a priori during system architecture phase of IC 100 such that a ‘FIFO full’ condition never occurs. In other alternative embodiments, the size of receive FIFO 156 may be implemented to be adjustable dynamically. Control then passes to step 420.

In step 420, DMA controller 120 stores the length as well as the data contents of the packet in receive FIFO 156. The storage format of the packet is similar to that described above with respect to FIG. 2B, and is not repeated here in the interest of conciseness. Control then passes to step 430.

In step 430, DMA controller 120 checks if any additional packet needs to be transferred to receive FIFO 156 from any of the peripherals (in peripherals block 130). If additional packets need to be transferred control passes to step 410, otherwise control passes to step 440.

In step 440, DMA controller 120 generates a single interrupt to CPU 110 for all the complete messages stored in receive FIFO 156 due to the operation of the loop of steps 410, 415, 420 and 430. That is, only one interrupt is sent to CPU 110 for the potentially several/many complete messages stored due to the operation of the loop. The flowchart ends in step 499.

In response to the single interrupt, CPU 110 may process the interrupt as described below with respect to flowchart of FIG. 5. The processing of the interrupt entails reading the data from the receive FIFO (which causes the read pointer to be changed) and then processing as appropriate (as described below in further detail). DMA controller 120 operates in parallel to CPU 110, and the corresponding interrupt service routine (ISR), and continues to check if packets need to be transferred from any of the peripherals, and performs the corresponding steps noted above. Thus, DMA controller 120 does not need to wait for CPU 110 to complete the ISR execution, and can proceed to receive new packet(s).

It may appreciated that since DMA controller 120 is designed to complete transfer of multiple packets (when available and required to be transferred) to receive FIFO 156 before generating an interrupt, overhead on CPU 110 is substantially reduced. The operation of the CPU in an embodiment is described below.

6. CPU Processing the Data in the Receive FIFO

FIG. 5 is a flowchart illustrating the manner in which a CPU reads data (sent by peripheral devices, and written in a receive FIFO by a DMA controller). The operations of the flowchart are performed in an interrupt service routine (ISR).The flowchart starts in step 501, in which control passes immediately to step 510.

In step 510, CPU 110 reads a packet from receive FIFO 156. Prior to reading however, CPU 110 may determine if new data is indeed present in receive FIFO 156. In an embodiment, such a determination may be made by CPU 110 by computing the difference of the contents of write (RWP) and read (RRP) pointers of receive FIFO 156, and checking if the difference is greater than zero. Following the determination, CPU 110 reads the length of the packet, and based on the length reads the corresponding number of data bytes (message) contained in the packet. CPU 110 may process the message in a desired manner. Control then passes to step 520.

In step 520, CPU 110 checks if another complete message is present in receive FIFO 156. In an embodiment, CPU 110 reads the length of such a message from the length field (similar to as in FIG. 2B), and then determining if [(RWP−RRP)>length], wherein ‘length’ represents the length of the message read by CPU 110. If CPU 110 determines that another complete packet is present, control passes to step 510, otherwise, control passes to step 599, in which the flowchart ends (representing an exit from the ISR).

Thus, in response to a single (only one) interrupt, CPU 110 may read (and possibly perform the corresponding processing) multiple packets in receive FIFO 156. The overhead on the CPU may accordingly be reduced. A description of DMA controller 120 as well as transmit FIFO 155 and receive FIFO 156, in an embodiment of the present invention, is provided next.

7. FIFO Implementation

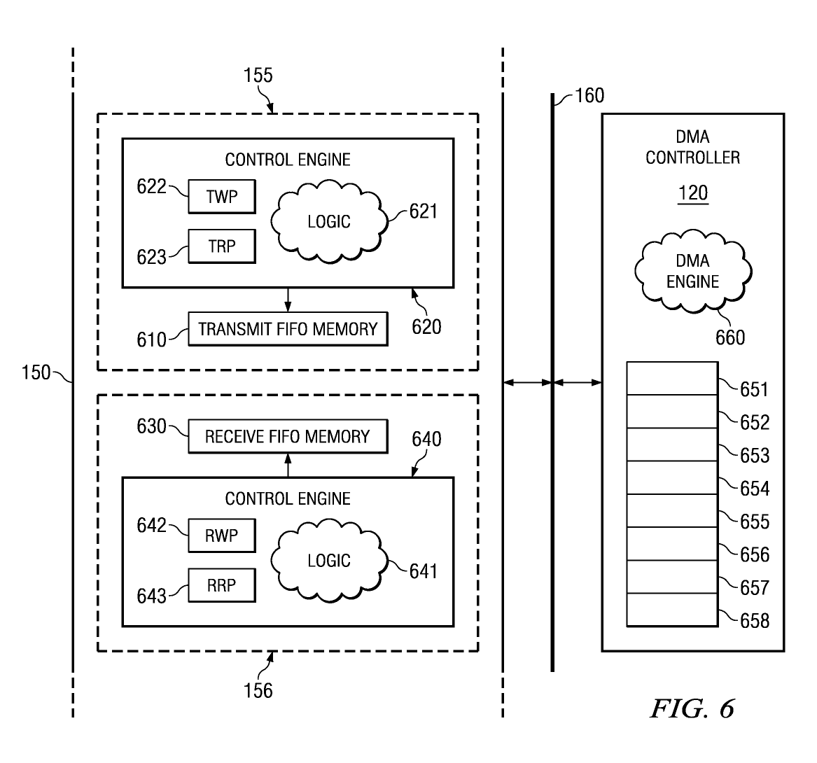

FIG. 6 is a block diagram illustrating relevant internal details of transmit FIFO 155 and receive FIFO 156 (contained within memory 150 of FIG. 1), and DMA controller 120, in an embodiment of the present invention. Transmit FIFO 155 is shown containing transmit FIFO memory 610, and control engine 620 containing logic 621, transmit write pointer (TWP) 622, and transmit read pointer (TRP) 623. Receive FIFO 156 is shown containing receive FIFO memory 630, and control engine 640 containing logic 641, receive write pointer (RWP) 642, and receive read pointer (RRP) 643. In an embodiment, all components/blocks of FIG. 6 are implemented as hardware units.

Transmit FIFO memory 610 represents memory locations for storage of data in transmit FIFO 155. Thus, Packet-1, Packet-2, and Packet-3 shown in FIG. 2B would be stored in transmit FIFO memory 610. Control engine 620, via logic 621, controls the operation of (e.g., accesses to, pointer increments, roll-overs, etc) transmit FIFO 155. TWP 622 stores the address of the memory location in transmit FIFO memory 610 to which data was last written, and transmit read pointer (TRP) 623 stores the address of the memory location in transmit FIFO memory 610 from which data was last read. Logic 621 increments the values in TWP 622 and TRP 623 as data is written and read from transmit FIFO memory 610.

Receive FIFO 156 is implemented substantially similar to transmit FIFO 155, with receive FIFO memory 630 representing data-storage area, and control engine 640 (via logic 641) controlling the operation, and receive write pointer (RWP) 642, and receive read pointer (RRP) 643 respectively storing the addresses (within receive FIFO memory 630) last written to and read from respectively.

In an embodiment, transmit FIFO 155 is implemented as a circular FIFO. Thus, when all locations of transmit FIFO memory 610 have been written to, a next write begins from the starting address of transmit FIFO memory 610. Values in TWP 622 and TRP 623 are correspondingly ‘rolled-over’ to such starting address by logic 621. Receive FIFO 156 is also implemented similarly as a circular FIFO.

DMA controller 120 is shown containing DMA engine 660 and registers 651 through 658. DMA engine 660 controls the operations of DMA controller 120. DMA controller 120 reads the values in TWP (622), TRP (623), RWP (642), and RRP (643) and stores the respective values in registers 651 through 654 respectively, thereby enabling DMA controller 120 to make the corresponding determinations described above with respect to flowcharts of FIGS. 3 and 4. It is noted that CPU 110 also reads the registers to enable the determinations described with respect to flowcharts 2A and 5.

Registers 655 and 656 respectively contain the upper and lower limits (memory addresses) of transmit FIFO memory 610. Registers 657 and 658 respectively contain the upper and lower limits (memory addresses) of receive FIFO memory 630. Transmit FIFO 155, receive FIFO 156 and DMA controller 120 may be implemented in a known way.

While described above as being implemented in hardware, transmit FIFO 155 and receive FIFO 156 may also be implemented as ‘virtual FIFOs’. In such an implementation, the storage locations in the FIFOs would be locations in general purpose RAM (such as RAM 151) in memory 150, with the either CPU 110 or corresponding executable modules stored in other portions of memory 150 designed to effect FIFO features in the storage locations.

Registers 655, 656, 657 and 658 (provided in DMA controller 120), but corresponding to the virtual FIFOs) may be programmed dynamically (during operation of IC 100) to increase/reduce the size (memory space) of the FIFO. In general, when substantial portion of the memory space is already written (and awaiting retrieval by or transfer to the destination), the size of the FIFO may be increased. The available memory space (e.g., in RAM 151) may be used for both the transmit and receive FIFOs (in addition to, for other purposes), and thus the size of the FIFOs may be reduced once the backlog is reduced (by retrieval of the corresponding data). Thus the approach enables the sizes of transmit FIFO 155 and receive FIFO 156 to be flexible and adjusted dynamically.

References throughout this specification to “one embodiment”, “an embodiment”, or similar language means that a particular feature, structure, or characteristic described in connection with the embodiment is included in at least one embodiment of the present invention. Thus, appearances of the phrases “in one embodiment”, “in an embodiment” and similar language throughout this specification may, but do not necessarily, all refer to the same embodiment.

While various embodiments of the present invention have been described above, it should be understood that they have been presented by way of example only, and not limitation. Thus, the breadth and scope of the present invention should not be limited by any of the above-described embodiments, but should be defined only in accordance with the following claims and their equivalents.

What is claimed is:

1. A digital processing system comprising:
a transmit first-in-first-out (FIFO) memory;
a processor to generate a sequence of packets destined to respective destination locations, and to store said sequence of packets in said transmit FIFO memory; and
a DMA controller to transfer each of said sequence of packets to corresponding destination location,
said DMA controller to send a single interrupt to said processor only after transferring a plurality of packets, said plurality of packets being contained in said sequence of packets.

2. The digital processing system of claim 1, wherein each of said sequence of packets contains a header and a message,
said processor to store a length of each message in the header of the packet, said processor to store the data corresponding to each packet in successive locations of said transmit FIFO memory,
said DMA controller to examine the length of a next message and a number of unread locations in said transmit FIFO memory to determine whether the complete packet is already stored in said transmit FIFO memory,
wherein said DMA controller sends said single interrupt after determining that there is no complete packet for transfer in said transmit FIFO memory.

3. The digital processing system of claim 2, wherein said DMA controller is designed to start transferring of a packet only after the corresponding packet is completely stored in said transmit FIFO memory.

4. The digital processing system of claim 2, further comprising:
a plurality of peripheral devices,
wherein said processor is designed to store a peripheral identifier in the header of the corresponding packet, the peripheral identifier identifying a peripheral device to which the corresponding packet is to be transferred, the destination location comprising said peripheral identifier,
said DMA controller being designed to transfer each packet to the peripheral device identified by the peripheral identifier in the header of the packet.

5. The digital processing system of claim 4, further comprising:
a receive FIFO memory, which is implemented as a separate unit from said transmit FIFO memory,
wherein said DMA controller is designed to retrieve a second sequence of packets from respective peripheral devices, and store each of said second sequence of packets in said receive FIFO memory, wherein the data corresponding to each packet is stored in consecutive locations of said receive FIFO memory,
said DMA controller being designed to send another single interrupt to said processor after storing at least two packets of said second sequence of packets in said receive FIFO memory.

6. The digital processing system of claim 5, wherein each packet in said sequence of packets contains a header,
said DMA controller to store a length of a message in each packet in said second sequence of packets in the header of the packet, said DMA controller to store the data corresponding to each packet in said second sequence of packets in successive locations of said receive FIFO memory,
said processor to examine the length of a next message and a number of unread locations in said receive FIFO memory to determine whether the complete packet is available in said receive FIFO memory,
wherein said processor continues reading complete packets sequentially until all complete packets are read in response to said another single interrupt.

7. The digital processing system of claim 2, wherein said transmit FIFO contains a read pointer and a write pointer, wherein said read pointer stores an address of a next location in said transmit FIFO from which data is to be read,
wherein said write pointer stores an address of a next location in said transmit FIFO at which data is to be written,
wherein said DMA controller computes said number of unread locations by subtracting the value in said read pointer from the value in said write pointer.

8. The digital processing system of claim 7, wherein said DMA controller determines that a complete packet is stored if the length in the header of the packet is not greater than said number of unread locations.

9. A method of transferring data in a digital processing system, said method comprising:
forming in a processor, a sequence of messages to be transferred to respective peripheral devices;
storing in a transmit FIFO said sequence of messages in the form of a sequence of packets;
transferring said sequence of packets from said transmit FIFO to respective peripheral devices; and
generating a single interrupt to said processor after transferring at least two packets of said sequence of packets.

10. The method of claim 9, wherein each of said sequence of packets contains a header and a corresponding message,
said storing stores a length of the message in the header of the packet,
said storing further stores the data corresponding to each packet in successive locations of said transmit FIFO memory,
said method further comprising:
examining by DMA controller, the length of a next message and a number of unread locations in said transmit FIFO memory to determine whether the complete packet is stored in said transmit FIFO memory,
sending said single interrupt after determining that there is no complete packet for transfer in said transmit FIFO memory.

11. The method of claim 10, further comprising starting transferring of a packet only after the corresponding packet is completely stored in said transmit FIFO memory.

12. The method of claim 10, wherein said storing stores a peripheral identifier in the header of the corresponding packet, the peripheral identifier identifying a peripheral device to which the corresponding packet is to be transferred,
said transferring to transfer each packet to the peripheral device identified by the peripheral identifier in the header of the packet.

13. The method of claim 10, further comprising:
retrieving a second sequence of packets from respective peripheral devices, and storing each of said second sequence of packets in a receive FIFO memory, wherein the data corresponding to each packet is stored in consecutive locations of said receive FIFO memory; and
sending another single interrupt to said processor after storing at least two packets of said second sequence of packets in said receive FIFO memory.

14. The method of claim 13, wherein each packet in said second sequence of packets contains a header,
wherein a length of a message in each packet in said second sequence of packets is stored in the header of the packet, and the data corresponding to each packet in said second sequence of packets are stored in successive locations of said receive FIFO memory, said method further comprising:
examining the length of a next packet and a number of unread locations in said receive FIFO memory to determine whether the complete packet is available in said receive FIFO memory; and
continuing, in said processor, reading complete packets sequentially until all complete packets are read in response to said another single interrupt.

15. The method of claim 10, wherein said transmit FIFO contains a read pointer and a write pointer, wherein said read pointer stores an address of a next location in said transmit FIFO from which data is to be read,
wherein said write pointer stores an address of a next location in said transmit FIFO at which data is to be written, said method further comprising:
computing in said DMA controller, said number of unread locations by subtracting the value in said read pointer from the value in said write pointer.

16. A digital processing system comprising:
a receive first-in-first-out (FIFO) memory;
a central processing unit (CPU);
a set of peripherals to generate a set of packets destined to said CPU; and
a DMA controller to transfer each of said set of packets to said receive FIFO memory,
said DMA controller to send a single interrupt to said processor only after transferring a plurality of packets to said receive FIFO memory, said plurality of packets being contained in said set of packets.

17. The digital processing system of claim 16, wherein said CPU is designed to retrieve said plurality of packets from said receive FIFO memory in response to said single interrupt.

18. The digital processing system of claim 17, wherein each of said sequence of packets contains a header,
said DMA controller to store a length of a message in each packet in the header of the packet, said DMA controller to store the data corresponding to each packet in successive locations of said receive FIFO memory,
said CPU to examine the length of a next message and a number of unread locations in said receive FIFO memory to determine whether the complete packet is stored in said receive FIFO memory,
wherein said CPU is designed to retrieve said plurality of packets stored in said receive FIFO until complete packets are determined to be present in said receive FIFO.

19. The digital processing system of claim 18, wherein said receive FIFO contains a read pointer and a write pointer, wherein said read pointer stores an address of a next location in said receive FIFO from which data is to be read,
wherein said write pointer stores an address of a next location in said receive FIFO at which data is to be written,
wherein said CPU computes a number of unread locations by subtracting the value in said read pointer from the value in said write pointer and determines whether a complete packet is present by comparing said number of unread locations with a length in the header of any next packet.

20. The digital processing system of claim 19, wherein said CPU determines that a complete packet is stored if the length in the header of the packet is not greater than said number of unread locations.
